(19) United States
(12) Patent Application Publication
(10) Pub. No.: US 2010/0236523 A1
(43) Pub. Date: Sep. 23, 2010

(54) APPARATUS FOR AND METHOD OF CONTROLLING INTERNAL COMBUSTION ENGINE

(75) Inventors: Masayuki Saruwatari, Isesaki (JP); Satoshi Kobayashi, Isesaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Automotive Systems, Ltd.

(21) Appl. No.: 12/727,345

(22) Filed: Mar. 19, 2010

(30) Foreign Application Priority Data
Mar. 23, 2009 (JP) 2009-070386

(51) Int. Cl. F02M 7/00; F01L 1/34; F02D 41/00

(52) U.S. Cl. 123/436; 123/90.15; 701/111

(57) ABSTRACT

Control apparatus performs knocking suppression control in an internal combustion engine provided with a variable valve mechanism that is capable of varying a closing timing IVC of an inlet valve. The control apparatus, in a case in which an alcohol concentration and octane number of a fuel are low and knocking is likely to occur, controls the variable valve mechanism and retards the closing timing of the inlet valve from the bottom dead center TDC. Thereby, the effective compression ratio is reduced and knocking occurrence is consequently suppressed.

### BACKGROUND OF THE INVENTION

1. Field of the Invention

The present invention relates to a control apparatus applied to an internal combustion engine provided with a variable valve mechanism that is capable of varying a closing timing of an inlet valve.

2. Description of Related Art

In Japanese Unexamined Patent Publication No. 2000-073804, it is disclosed that in an internal combustion engine having a variable compression ratio mechanism, if knocking occurs, the compression ratio is reduced by the variable compression ratio mechanism.

Incidentally, in the variable compression ratio mechanism that changes the piston top dead center position, there is a problem in that it has a complex structure and the cost thereof is high. Moreover, it is difficult to change the compression ratio with respect to a knocking occurrence, at a high level of responsiveness.

### SUMMARY OF THE INVENTION

It is therefore an object of the present invention to provide a control apparatus of an internal combustion engine that is of low cost and is capable of avoiding knocking at a high level of responsiveness, and a control method thereof.

To achieve the above object, a control apparatus according to the present invention is a control apparatus applied to an internal combustion engine provided with a variable valve mechanism that is capable of varying a closing timing of an inlet valve, and includes: a detection unit that detects a knocking occurrence condition in the internal combustion engine; and a control unit that controls the variable valve mechanism based on the knocking occurrence condition detected by the detection unit, and that changes a closing timing of the inlet valve according to the knocking occurrence condition.

Moreover, a control method according to the present invention is a control method of an internal combustion engine having a variable valve mechanism that is capable of varying a closing timing of an inlet valve, that detects a condition of a knocking occurrence in the internal combustion engine, and
controls the variable valve mechanism based on the knocking occurrence condition, to thereby change a closing timing of the inlet valve according to the knocking occurrence condition.

The other objects and features of this invention will become understood from the following description with reference to the accompanying drawing.

### BRIEF DESCRIPTION OF THE DRAWINGS

FIG. 1 is a view showing a system of a vehicle internal combustion engine provided with a variable valve timing mechanism, in an embodiment;

FIG. 2 is a sectional view of the variable valve timing mechanism, in the embodiment;

FIG. 3 is a flowchart showing control of closing timing IVC according to alcohol concentration, in the embodiment;

FIG. 4 is a flowchart showing control of the variable valve timing mechanism, in the embodiment;

FIGS. 5A and 5B are views showing an example of differences in closing timing IVC depending on alcohol concentration, in the embodiment;

FIG. 6 is a flowchart showing control of closing timing IVC according to octane number, in the embodiment;

FIG. 7 is a flowchart showing control of closing timing IVC according to alcohol concentration and octane number, in the embodiment;

FIG. 8 is a flowchart showing control of closing timing IVC according to knocking vibration, in the embodiment;

FIG. 9 is a view showing a system of a vehicle internal combustion engine provided with a variable valve timing mechanism and a variable valve lift mechanism, in the embodiment;

FIG. 10 is a perspective view showing the variable valve lift mechanism, in the embodiment;

FIG. 11 is a side view of the variable valve lift mechanism, in the embodiment; and

FIG. 12 is a flowchart showing control of the variable valve timing mechanism and the variable valve lift mechanism, in the embodiment.

### DESCRIPTION OF THE PREFERRED EMBODIMENTS

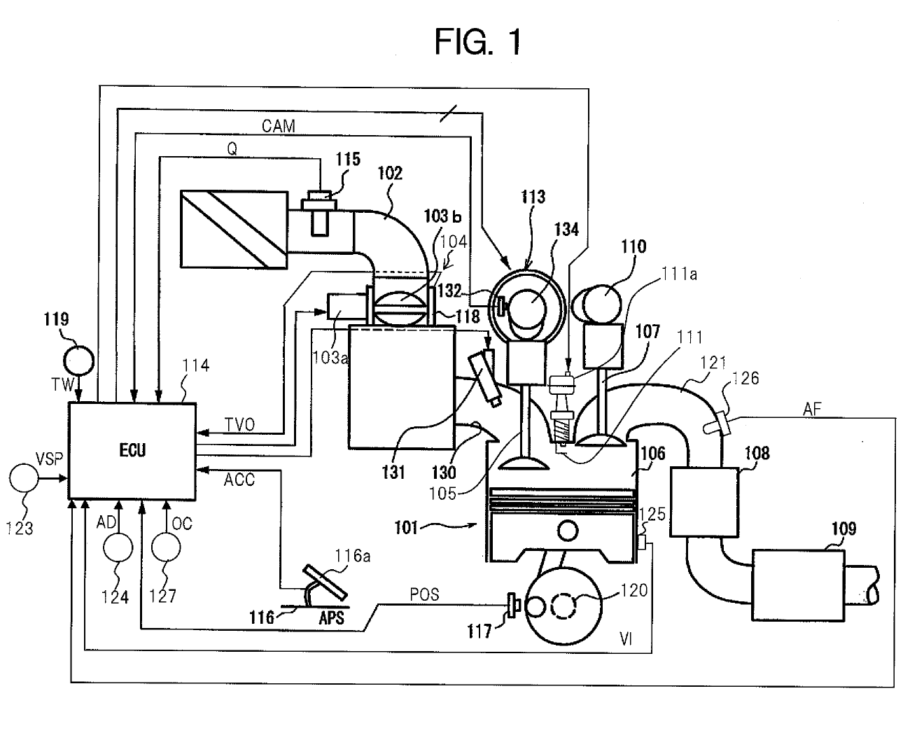

FIG. 1 is a block diagram of a vehicle internal combustion engine 101 to which a control apparatus according to the present invention is applied.

In internal combustion engine 101 shown in FIG. 1, in addition to gasoline, a mixed fuel of gasoline and alcohol may be used.

The mixed fuel may be stored in a fuel tank as a preliminarily mixed fuel, or gasoline and alcohol may be separately stored in fuel tanks, and then the gasoline and alcohol may be mixed when they are supplied to internal combustion engine 101.

Internal combustion engine 101 in the present embodiment is an inline four-cylinder engine, however it may also be a V-type engine or a horizontally opposed engine. Moreover, the number of cylinders may be four or more.

On an inlet pipe 102 of internal combustion engine 101, there is provided an electronically controlled throttle 104 that drives a throttle valve 103b open and close with a throttle motor 103a.

Internal combustion engine 101 sucks air into a combustion chamber 106 via electronically controlled throttle 104 and an inlet valve 105.

On an inlet port 130 of each cylinder there is provided a fuel injection valve 131.

Internal combustion engine 101 may be a cylinder direct injection type internal combustion engine in which fuel injection valve 131 directly injects fuel into combustion chamber 106.

Fuel injection valve 131 is opened by an injection pulse signal from an ECU (engine control unit) 114, and injects fuel.

The fuel within combustion chamber 106 is ignited and combusted by spark ignition of an ignition plug 111.

On each of ignition plugs 111 there is provided an ignition module 111a internally having an ignition coil and a power transistor that controls power distribution to the ignition coil.

Exhaust gas travels from the interior of combustion chamber 106 though an exhaust valve 107 to an exhaust pipe 121, and is purified when passing through a front catalytic converter 108 and a rear catalytic converter 109 arranged in exhaust pipe 121, and is discharged into the atmosphere.

Inlet valve 105 and exhaust valve 107 are respectively driven by cams integrally provided on an inlet camshaft 134 and an exhaust camshaft 110.

On the inlet camshaft 134 there is provided a variable valve timing mechanism 113.

Variable valve timing mechanism 113 is a variable valve mechanism that changes a rotation phase of inlet camshaft 134 with respect to a crankshaft 120 to thereby change a valve timing of inlet valve 105, in other words, change a central phase of the valve working angle. Moreover variable valve timing mechanism 113 changes an opening timing IVO and a closing timing IVC of inlet valve 105 while the valve working angle is maintained constant.

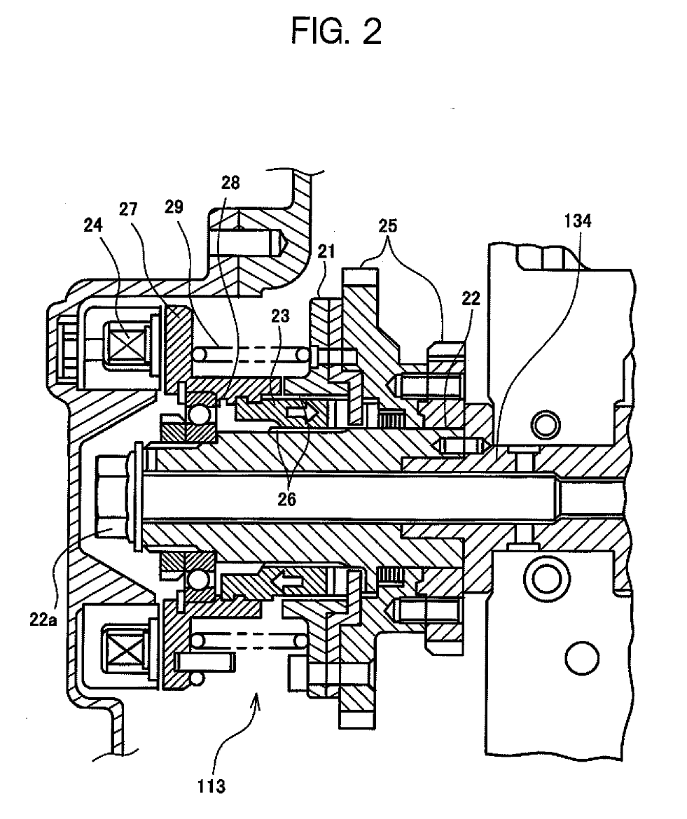

FIG. 2 shows a structure of variable valve timing mechanism 113.

Variable valve timing mechanism 113 is provided with: a first rotating body 21 that is fixed on a sprocket 25 that rotates in synchronization with crankshaft 120, and rotates integrally with this sprocket 25; a second rotating body 22 that is fixed on one end of inlet camshaft 134 with a bolt 22a, and rotates integrally with inlet camshaft 134; and a cylindrical intermediate gear 23 that engages, via helical splines 26, with the inner peripheral surface of first rotating body 21 and the outer peripheral surface of second rotating body 22.

To intermediate gear 23 is connected a drum 27 via a triple thread screw 28, and a torsional spring 29 is interposed between drum 27 and intermediate gear 23.

Intermediate gear 23 is urged in the retard direction (left direction in FIG. 2) by torsional spring 29, and when a voltage is applied to an electromagnetic retarder 24 to generate a magnetic force, it is moved in the advance direction (right direction in FIG. 2) via drum 27 and triple thread screw 28.

According to the axial position of this intermediate gear 23, the relative phase of rotating bodies 21 and 22 changes, and the phase of inlet camshaft 134 with respect to crankshaft 120 changes.

Electromagnetic retarder 24 operates according to a manipulated value output from ECU 114, and the phase of inlet camshaft 134, that is, the valve timing of inlet valve 105, changes according to the manipulated value.

Variable valve timing mechanism 113 is not limited to the structure shown in FIG. 2, and may appropriately select and employ a commonly known variable valve timing mechanism that changes the rotation phase of a camshaft with respect to a crankshaft. For example, there may be adopted a variable valve timing mechanism disclosed in Japanese Laid-open (Kokai) Patent Application Publication No. 2003-184516 that is provided with a movable guiding section that is engaged displaceably with a helical guide, or there may be employed a hydraulic vane type variable valve timing mechanism disclosed in Japanese Laid-open (Kokai) Patent Application Publication No. 2007-120406.

ECU 114 has a built-in micro computer, and it processes detection signals from various types of sensors according to a pre-stored program, to thereby control electronically controlled throttle 104, variable valve timing mechanism 113, fuel injection valve 131, ignition module 111a, and the like.

As the various types of sensors, there are provided: an accelerator opening sensor 116 that detects a step-on amount APS of an accelerator pedal 116a; an airflow sensor 115 that detects an intake air quantity Q of internal combustion engine 101; a crank angle sensor 117 that outputs a detection signal POS according to rotation of crankshaft 120; a throttle sensor 118 that detects an opening TVO of throttle valve 103b; a temperature sensor 119 that detects a temperature TW of the cooling water of internal combustion engine 101; a cam sensor 132 that outputs a detection signal CAM according to rotation of inlet camshaft 134; a vehicle speed sensor 123 that detects a vehicle travelling speed VSP; an alcohol concentration sensor 124 that detects an alcohol concentration AD in a mixed fuel injected from fuel injection valve 131; a knocking sensor 125 that, with use of a piezoelectric device or the like, detects vibration VI of internal combustion engine 101 when knocking is occurring; and an air-fuel ratio sensor 126 that is provided in exhaust pipe 121 on the upstream side of front catalytic converter 108 and that detects an air-fuel ratio AF based on oxygen concentration in the exhaust gas.

As alcohol concentration sensor 124 there may be adopted a capacitance type alcohol concentration sensor such as disclosed in Japanese Laid-open (Kokai) Patent Application Publication No. H07-167816.

ECU 114 calculates engine rotation speed NE based on the detection signal POS output from crank angle sensor 117. Moreover, ECU 114 calculates a base fuel injection amount TP of fuel injection valve 131 based on the engine rotation speed NE and the intake air quantity Q.

Moreover, ECU 114 calculates first to third correction coefficients for correcting the base fuel injection amount TP, and corrects the base fuel injection amount TP, using the calculated first to third correction coefficients, to thereby calculate a final fuel injection amount TI.

ECU 114 calculates the first correction coefficient according to the alcohol concentration AD in the mixed fuel detected by alcohol concentration sensor 124. Moreover, ECU 114 calculates the second correction coefficient according to the temperature TW or the like of the cooling water. Furthermore, ECU 114 calculates the third correction coefficient according to the air-fuel ratio AF detected by air-fuel ratio sensor 126.

To describe in more detail, in order to generate an air-fuel mixture close to a target air-fuel ratio even if the alcohol concentration in the fuel changes, ECU 114 sets the first correction coefficient so that the fuel injection amount increases as the alcohol concentration becomes higher. Moreover, ECU 114 sets the second correction coefficient so that the fuel injection amount increases as the temperature of internal combustion engine 101 becomes lower and the temperature TW of the cooling water becomes lower.

Furthermore, ECU 114 sets the third correction coefficient based on a deviation between the air-fuel ratio AF detected by air-fuel ratio sensor 126, and the target air-fuel ratio, so that the air-fuel ratio AF detected by air-fuel ratio sensor 126 approaches the target air-fuel ratio. When the air-fuel ratio AF is leaner than the target air-fuel ratio, it increases the third correction coefficient to thereby increase the fuel injection amount, and when the air-fuel ratio AF is richer than the target air-fuel ratio, it reduces the third correction coefficient to thereby reduce the fuel injection amount.

Moreover, ECU 114 outputs an injection signal of a pulse duration corresponding to the fuel injection amount TI, to fuel injection valve 131 so as to match with the timing of an intake stroke of each cylinder, to thereby supply fuel to each cylinder of engine 101.

Incidentally, an alcohol based fuel such as ethanol has a higher anti-knocking property than gasoline, and therefore knocking is more unlikely to occur with a higher alcohol concentration AD in the mixed fuel. On the contrary, knocking is more likely to occur with a lower alcohol concentration AD in the mixed fuel.

Consequently, in ECU 114, in order to suppress knocking from occurring, variable valve timing mechanism 113 is controlled according to the alcohol concentration AD of the mixed fuel.

That is to say, when the closing timing IVC of inlet valve 105 is a timing later than the bottom dead center BDC, compression starts from the middle of the compression stroke, and consequently, the effective compression ratio is reduced, and abnormal combustion, which is a factor that contributes to knocking, becomes more unlikely to occur due to the reduction in the compression ratio.

On the other hand, when the closing timing IVC of inlet valve 105 is advanced from the timing after the bottom dead center BDC to be brought to close to the bottom dead center BDC, the effective compression ratio is increased and combustion efficiency is increased.

Therefore, when the closing timing IVC of the inlet valve 105 is changed according to the concentration AD of alcohol, the fuel property of which correlates with the anti-knocking property, it can be set to a highest possible effective compression ratio while suppressing knocking from occurring. Consequently, it is possible to achieve knocking suppression as well as a high level of combustion efficiency.

Moreover, as described above, since the closing timing IVC of inlet valve 105 is made later than the bottom dead center BDC to thereby decrementally change the effective compression ratio, the base compression ratio can be set to a high value of the order of “12”. As a result, in an operation range where there is used a fuel that is unlikely to cause knocking such as a mixed fuel having a high alcohol concentration, and where knocking is unlikely to occur, it is possible, with a high compression ratio, to achieve a high level of combustion efficiency.

The base compression ratio is a ratio between the total cylinder volume when the piston is at the bottom dead center, and the cylinder volume that remains above the piston when the piston is at the top dead center.

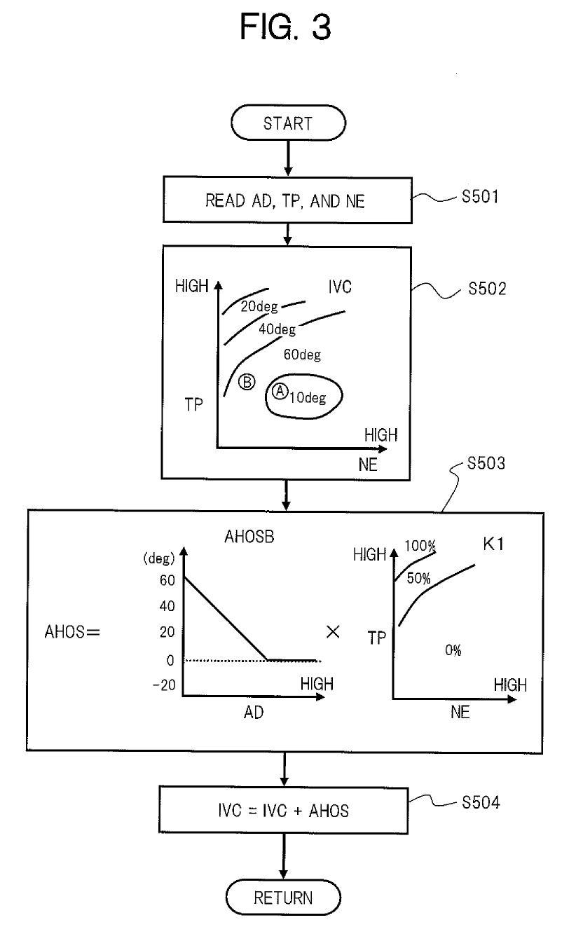

The flowchart of FIG. 3 is a routine showing a control of the closing timing IVC according to the alcohol concentration AD, performed by ECU 114. This routine is executed interruptingly at constant time intervals.

In the flowchart of FIG. 3, in step S501, data including; alcohol concentration AD detected by alcohol concentration sensor 124, engine torque TP, engine rotation speed NE, and the like are read.

As the engine torque, in other words, a property showing engine load, there may be used the base fuel injection amount TP or the like.

Moreover, in a case in which internal combustion engine 101 is not provided with alcohol concentration sensor 124, or in a case in which alcohol concentration sensor 124 fails, the alcohol concentration AD of the mixed fuel may be estimated based on the third correction coefficient.

For example, in a case in which fuel injection is performed on an assumption that a 100% gasoline fuel is in use, if the fuel actually in use is an alcohol mixed fuel, the air-fuel ratio to be detected by air-fuel ratio sensor 126 becomes leaner than the theoretical air-fuel ratio as the alcohol concentration AD becomes higher. Therefore, the third correction coefficient is set to a greater value as the alcohol concentration AD becomes higher, and the fuel injection amount is corrected to increase. Consequently, it is possible to estimate that the alcohol concentration AD of the fuel in use becomes higher as the value of the third correction coefficient becomes greater.

In step S502, a base value of the target closing timing IVC is calculated based on the engine torque TP and engine rotation speed NE indicating the operating conditions of internal combustion engine 101.

In the present embodiment, the closing timing IVC is shown by an angle from the bottom dead center BDC to the closing timing IVC. Moreover, the retard direction from the bottom dead center BDC is shown as positive and the advance direction from the bottom dead center BDC is shown as negative. Therefore, in a case in which the closing timing IVC is 0 deg, the bottom dead center BDC is the closing timing IVC of the inlet valve 105. As the closing timing IVC becomes greater than 0 deg, the closing timing IVC of the inlet valve 105 is set to a timing after the bottom dead center BDC.

In step S502, the target closing timing IVC is set, across the entire operating range, to a timing after the bottom dead center BDC. To describe in detail, in a moderate load/moderate rotation range (range A), which is a steady travelling range, there is set a closing timing IVC (IVC=ABDC 10 deg) closest to the bottom dead center BDC, and in a range B that surrounds this moderate load/moderate rotation range, there is set a closing timing IVC (IVC=ABDC 60 deg) that is most retarded from the bottom dead center BDC, so that the closing timing IVC is most advanced as the rotation speed becomes lower than and the load becomes higher than those in the range B.

In step S503, a correction value AHOS is calculated for retard-correcting the target closing timing IVC according to the alcohol concentration AD.

The correction value AHOS is set by multiplying a base value AHOSB (≧0), which is set to a greater value as the alcohol concentration AD becomes lower, in other words, as knocking becomes more likely to occur, by a correction coefficient K1 according the engine torque TP and engine rotation speed NE.

The correction coefficient K1 is preliminarily set according to the likelihood of knocking occurrence depending on the operating conditions of internal combustion engine 101. It is set to a greater value in a low rotation/high load range where the engine rotation speed NE is low, engine load TP is high, and knocking is likely to occur. It is set to a value between a minimum value 0% and a maximum value 100% according to the engine rotation speed NE and engine load TP.

In step S504, a value found by adding the alcohol correction value AHOS found in step S503 to the target closing timing IVC found in step S502, is set as a final target closing timing IVC.

Therefore, when the alcohol concentration AD of the mixed fuel is low, and the engine operating conditions are such that the occurrence of knocking is likely, the correction value AHOS is set to the greatest value, and the closing timing IVC is set to a crank angle that is most retarded from the bottom dead center BDC.

On the other hand, when the alcohol concentration AD of the mixed fuel is high, and the engine operating conditions are such that the occurrence of knocking is unlikely, the correction value AHOS is set to the smallest value, and the closing timing IVC is set to a crank angle that is closest to the bottom dead center BDC.

As a result, if the alcohol concentration AD of the mixed fuel is high, a high effective compression ratio can be set, and thereby a high level of combustion efficiency can be obtained. On the other hand, if the alcohol concentration AD of the mixed fuel is low, the effective compression ratio is set low to thereby suppress the occurrence of knocking.

Here, regarding variable valve timing mechanism 113, in general, the cost is lower and the operating speed is faster than a variable compression ratio mechanism. Therefore if, with use of variable valve timing mechanism 113, the closing timing IVC is changed to thereby change the effective compression ratio, it is possible to change the effective compression ratio at a high level of responsiveness with respect to differences in the likelihood of knocking occurrence associated with differences in alcohol concentration AD, and reduce the cost of internal combustion engine 101.

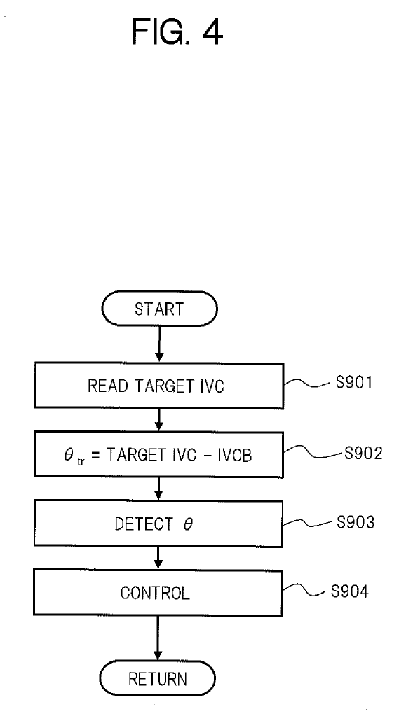

Control of variable valve timing mechanism 113 by ECU 114 based on the target closing timing IVC, is performed in accordance with the flowchart in FIG. 4. The routine shown in the flowchart in FIG. 4 is executed interruptingly at constant time intervals.

First in step S901, a target closing timing IVC calculated according to the flowchart in FIG. 3 is read.

In the next step S902, a closing timing IVCB at the initial state of variable valve timing mechanism 113 is subtracted from the target closing timing IVC read in step S901, to thereby find a target conversion angle θₜᵣ.

The closing timing IVCB at the initial state of variable valve timing mechanism 113 is set for example to the most retarded angle position after the bottom dead position.

In the next step S903, an actual conversion angle θ is detected based on a detection signal from crank angle sensor 117 and a detection signal from cam sensor 132.

Specifically, a reference crank angle is detected based on the detection signal from crank angle sensor 117, and an angle from the reference crank angle to a reference cam angle detected by cam sensor 132 is detected, to thereby find the rotation phase of inlet camshaft 134 with respect to crankshaft 120, that is, the actual conversion angle θ.

In step S904, the target conversion angle θₜᵣ is compared with the actual conversion angle θ detected with use of crank angle sensor 117 and cam sensor 132, and a manipulated value of electromagnetic retarder 24 is calculated so as to bring the actual conversion angle θ close to the target conversion angle θₜᵣ, and the manipulated value is output to electromagnetic retarder 24.

Specifically, the manipulated value is calculated by a proportional operation, an integration operation, and a differential operation, based on the deviation between the target conversion angle θₜᵣ and the actual conversion angle θ, and a switching device that switches electric power supply to electromagnetic retarder 24 is driven according to the manipulated value.

The target conversion angle θₜᵣ is a crank angle from the closing timing IVCB to the target closing timing IVC at the initial state of variable valve timing mechanism 113, and for example, if the closing timing IVCB at the initial state of variable valve timing mechanism 113 is at the most retarded position, it is an advanced angle from this most retarded angle position.

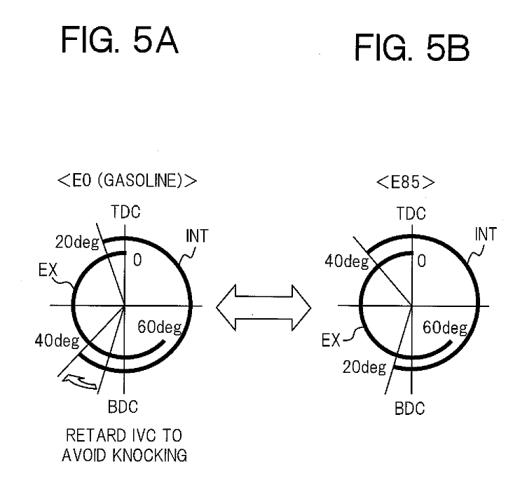

FIGS. 5A and 5B show differences in valve timing of inlet valve 105 depending on differences in the alcohol concentration AD. FIG. 5A shows a case of using a 100% gasoline fuel E0 and FIG. 5B shows a case of using a fuel E85 with alcohol concentration 85%.

Here, in the case of using the fuel E85 with alcohol concentration 85%, the closing timing IVC is set to a position 20 deg (ABDC 20 deg) after the bottom dead center, whereas in the case of using the 100% gasoline fuel E0, the closing timing IVC is retarded to a position 40 deg (ABDC 40 deg) after the bottom dead center.

If the closing timing IVC of the inlet valve 105 is more retarded from the bottom dead center BDC, the effective compression ratio is lowered and knocking occurrence becomes more unlikely. Therefore, when the alcohol concentration AD is lower and knocking occurrence is more likely, if the closing timing IVC is retarded, the effective compression ratio can be set to a highest possible ratio within a range where knocking occurrence can be suppressed, and knocking suppression and a high level of combustion efficiency can be both achieved.

Incidentally, in the above embodiment, with a gasoline fuel with alcohol concentration 0%, the base value AHOSB is constant and the closing timing IVC is changed according to the likelihood of knocking occurrence associated with engine operating conditions. However, even with a gasoline fuel with alcohol concentration 0%, the anti-knocking property varies depending on differences in octane number OC, and consequently the optimum closing timing IVC varies.

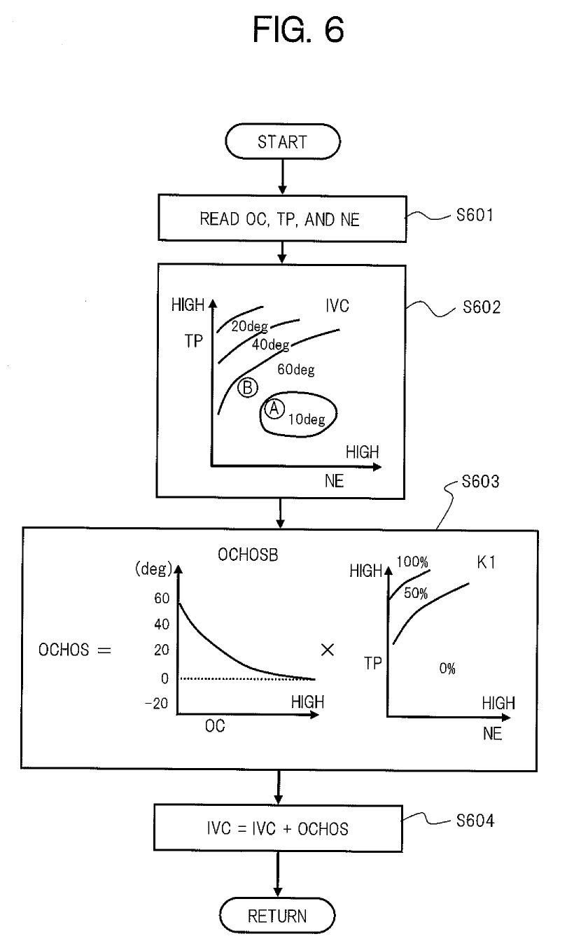

Therefore, an embodiment with a configuration related thereto, in which the closing timing IVC can be changed according to the octane number of a gasoline fuel, is described according to the flowchart in FIG. 6.

In a case of changing the closing timing IVC according to the octane number of the gasoline fuel, as shown in FIG. 1, there is provided an octane number sensor 127 that detects the octane number OC of the gasoline fuel. Octane number sensor 127 is, for example, a sensor that detects a specific gravity that correlates to an octane number according to a difference in the refractive index of the fuel.

The flowchart in FIG. 6 shows a routine that is executed interruptingly by ECU 114 at constant time intervals. First in step S601, data including; octane number OC of the gasoline fuel detected by octane number sensor 127, engine torque TP, engine rotation speed NE, and the like are read.

Moreover, in a case in which internal combustion engine 101 is not provided with octane number sensor 127, or in a case in which octane number sensor 127 fails, the octane number OC may be estimated based on the detection result of knocking sensor 125.

For example, under a condition where a gasoline fuel is used, as an initial state, ignition is performed based on a retarded side ignition timing suited to a gasoline fuel having the lowest octane number, and the ignition timing is gradually advanced until knocking sensor 125 has detected a knocking occurrence, to thereby find the ignition timing immediately prior to the knocking occurrence.

Here, since knocking is more unlikely to occur and the ignition timing can be made more advanced when the octane number OC of the gasoline fuel is higher, it is possible to estimate the octane number OC of the gasoline fuel based on how much of ignition timing advance with respect to the initial ignition timing has been possible.

Instead of detecting the presence or absence of knocking occurrence with use of knocking sensor 125 which is a piezoelectric device, knocking occurrence can be detected based on sound, ionic current within the combustion chamber, variations in crank angle speed, and the like.

In step S602, as with step S502, a base value of the target closing timing IVC is calculated based on the engine torque TP and engine rotation speed NE indicating the operating conditions of internal combustion engine 101.

In step S603, a correction value OCHOS for correcting the target closing timing IVC is calculated according to the octane number OC of the gasoline fuel.

The correction value OCHOS is found by multiplying a base value OCHOSB (≧0) which is set to a greater value as the octane number OC becomes lower, in other words, as knocking becomes more likely to occur, by a correction coefficient K1 according the engine torque TP and engine rotation speed NE.

The correction coefficient K1, as described in step S503, is preliminarily set according to the likelihood of knocking occurrence based on the operating conditions of internal combustion engine 101.

Moreover, the base value OCHOSB shown in the flowchart illustrates a characteristic that continuously makes incremental changes with an inclination with respect to reduction in the octane number OC. However, for example, the octane number OC can be determined between two types of octane numbers namely a high octane number corresponding to high-octane gasoline and a low octane number corresponding to regular gasoline. In this case, either one of the greater value or the smaller value of these two values is selected as the base value OCHOSB.

Furthermore, when the octane number OC of the gasoline fuel is low, and the engine operating conditions are such that knocking occurrence is more likely, the correction value OCHOS is set to the maximum value. On the other hand, when the octane number OC of the gasoline fuel is high and the engine operating conditions are such that knocking occurrence is more unlikely, the correction value OCHOS is set to the minimum value.

In step S604, the final target closing timing IVC is calculated by adding the correction value OCHOS found in step S603 to the target closing timing IVC found in step S602.

Control of variable valve timing mechanism 113 based on the target closing timing IVC is performed in accordance with the flowchart in FIG. 4 described above.

With the above control, as the octane number OC of the gasoline fuel becomes higher, the closing timing IVC of inlet valve 105 is brought closer to the bottom dead center BDC so that the effective compression ratio becomes even higher. On the other hand, as the octane number OC of the gasoline fuel becomes lower, the closing timing IVC is brought to a more retarded position after the bottom dead center BDC so that the effective compression ratio becomes even lower.

As a result, when the octane number OC of the gasoline fuel is high, a high effective compression ratio can be set, and thereby a high level of combustion efficiency can be obtained. On the other hand, when the octane number OC of the gasoline fuel is low, the effective compression ratio is set low to thereby suppress the occurrence of knocking.

Here, regarding variable valve timing mechanism 113, in general, the cost is lower and the operating speed is faster than a variable compression ratio mechanism. Therefore if, with use of variable valve timing mechanism 113, the closing timing IVC is changed to thereby change the effective compression ratio, it is possible to change the effective compression ratio at a high level of responsiveness with respect to differences in the likelihood of knocking occurrence associated with differences in octane number OC, and reduce the cost of internal combustion engine 101.

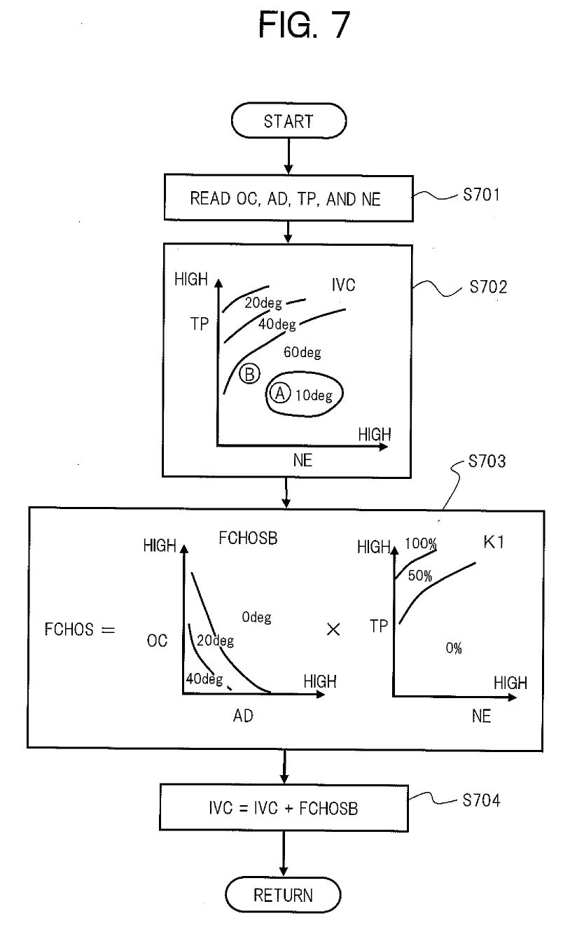

Incidentally, in the control described above, the closing timing IVC of inlet valve 105 was set based on either one of; the alcohol concentration AD and the octane number OC of the gasoline fuel. However, in a case of using an alcohol mixed fuel, the closing timing IVC of inlet valve 105 can be set based on both the alcohol concentration AD and the octane number OC of the gasoline fuel. An embodiment with a configuration related thereto, is explained according to the flowchart in FIG. 7.

The flowchart in FIG. 7 shows a routine that is executed interruptingly by ECU 114 at constant time intervals. First in step S701, data including; alcohol concentration AD detected by alcohol concentration sensor 124, octane number OC of a gasoline fuel detected by octane number sensor 127, engine torque TP, engine rotation speed NE, and the like are read.

The octane number OC, as described above, can be estimated based on the correction value for the ignition timing based on the detection results of the knocking sensor 125. Moreover, the alcohol concentration AD can be estimated based on the correction value for the fuel injection amount in accordance with the air-fuel ratio feed back control.

In step S702, as with step S502, a base value of the target closing timing IVC is calculated based on the engine torque TP and engine rotation speed NE indicating the operating conditions of internal combustion engine 101.

In step S703, a correction value FCHOS for correcting the target closing timing IVC is calculated according to the alcohol concentration AD and the octane number OC of the gasoline fuel.

The correction value FCHOS is found by multiplying a base value FCHOSB (≧0) which is set according to the alcohol concentration AD and the octane number OC, by a correction coefficient K1 according to the engine torque TP and engine rotation speed NE.

The base value FCHOSB, as shown in the flowchart, is set to a greater value as the alcohol concentration AD becomes lower and knocking occurrence becomes more likely. Furthermore, it is also set to a greater value as the octane number OC of the gasoline fuel becomes lower and knocking occurrence becomes more likely.

Moreover, the correction coefficient K1, as with step S503, is preliminarily set according to the likelihood of knocking occurrence based on the operating conditions of internal combustion engine 101.

In step S704, the final target closing timing IVC is calculated by adding the correction value FCHOS found in step S703 to the target closing timing IVC found in step S702.

Control of variable valve timing mechanism 113 based on the target closing timing IVC is performed in accordance with the flowchart in FIG. 4 described above.

According to the above embodiment, the closing timing IVC of the inlet valve 105 is set according to both the likelihood of knocking occurrence, which differs according to the alcohol concentration AD, and the likelihood of knocking occurrence, which differs according to the octane number OC of the gasoline fuel. Therefore it is possible, with respect to variations in the alcohol concentration AD and variations in the octane number OC of the gasoline fuel mixed with the alcohol fuel, to set the effective compression ratio to a highest possible ratio while suppressing knocking occurrence

As described above, in a case in which knocking sensor 125 has detected knocking occurrence in a state where the target closing timing IVC is controlled according the alcohol concentration AD and/or the octane number OC of the gasoline fuel, it is possible to suppress knocking by correcting the retardation of the ignition timing or by incrementally correcting an exhaust gas recirculation amount.

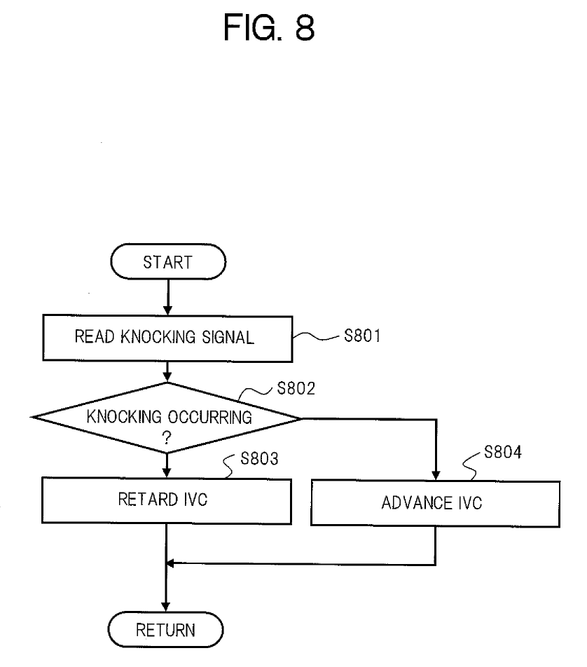

Moreover, it is also possible to change the closing timing IVC of the inlet valve 105 according to the presence or absence of knocking occurrence. An embodiment with a configuration related thereto is described according to the flowchart in FIG. 8.

The flowchart in FIG. 8 shows a routine that is executed interruptingly by ECU 114 at constant time intervals. First in step S801, a signal from knocking sensor 125 is read.

In the next step S802, it is determined, based on the signal from the knocking sensor 125, whether or not knocking vibrations are occurring.

Then, if in a state where knocking vibrations are occurring, control proceeds to step S803 where the target closing timing IVC of the inlet valve 105 is corrected so as to be retarded only by a correction value ΔRTD (deg) that is pre-stored based on the previous value.

In other words, in response to the knocking vibrations, the closing timing IVC of the inlet valve 105 is changed to a more retarded timing after the bottom dead center BDC to thereby reduce the effective compression ratio and suppress knocking vibrations.

Here, the variable valve timing mechanism 113 is such that it has a higher level of responsiveness in the knocking suppressing operation compared to a general variable compression ratio mechanism, and response time thereof from the moment of detection of knocking occurrence to the moment it becomes able to actually suppress knocking is shorter than that of the variable compression ratio mechanism. Consequently it is possible to quickly suppress knocking.

On the other hand, in a case in which knocking vibrations are not occurring, control proceeds to step S804 where the target closing timing IVC of inlet valve 105 is corrected so as to be advanced only by a correction value ΔADV (deg) that is pre-stored based on the previous value.

In other words, in the case in which knocking vibrations are not occurring, the closing timing IVC of inlet valve 105 is advanced-corrected so as to be brought closer to the bottom dead center BDC, and the effective compression ratio is increased to thereby improve the combustion efficiency.

Control of variable valve timing mechanism 113 based on the target closing timing IVC corrected according to the presence or absence of knocking vibration occurrence, is performed in accordance with the flowchart in FIG. 4 described above.

By setting the correction value ΔRTD to an angle greater than the correction value ΔADV, it is possible to quickly resolve a knocking occurring state while suppressing the occurrence of hunting. Moreover, the correction values ΔRTD and ΔADV are preliminarily optimized so that the closing timing IVC will not be excessively retarded and the closing timing IVC can be advanced until just before knocking occurs.

Moreover, it is also possible, with the target closing timing IVC according to the alcohol concentration AD, octane number OC, or engine operating state serving as a base value, to correct the target closing timing IVC according to the presence or absence of knocking occurrence.

Furthermore, in a case in which the maximum retarded angle amount of the closing timing IVC is set but knocking cannot be suppressed even if the closing timing IVC is retarded as much as the maximum retarded angle amount, knocking can be suppressed by retard-correcting the ignition timing or by incrementally correcting an exhaust gas recirculation amount.

Incidentally, internal combustion engine 101 of the above embodiment is provided with variable valve timing mechanism 113 serving as a variable valve mechanism. However, a similar effect can also be obtained in an internal combustion engine 101 that, together with variable valve timing mechanism 113, is provided with a variable valve lift mechanism 112 that is capable of varying the valve operating angle together with the maximum valve lift amount of inlet valve 105, by executing control of the closing timing IVC according to the fuel properties such as alcohol concentration and octane number, and the presence or absence of knocking occurrence as described above.

Moreover, at or after start-up, the target closing timing IVC is set according to the flowchart in any one of FIG. 3, FIG. 6, and FIG. 7. Then this target closing timing IVC is set as shown in the flowchart in FIG. 8, and thereby a correction can be made according to the presence or absence of knocking occurrence.

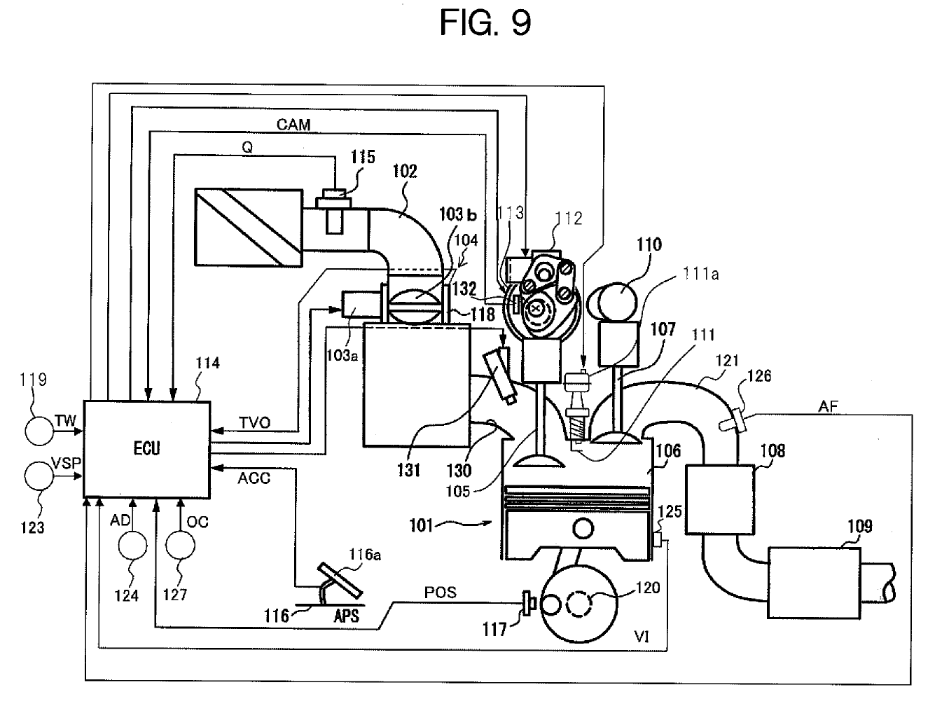

FIG. 9 shows internal combustion engine 101 provided with variable valve lift mechanism 112 as well as variable valve timing 113. However, components the same as those of internal combustion engine 101 shown in FIG. 1 are denoted by the same reference symbols and detailed descriptions thereof are omitted.

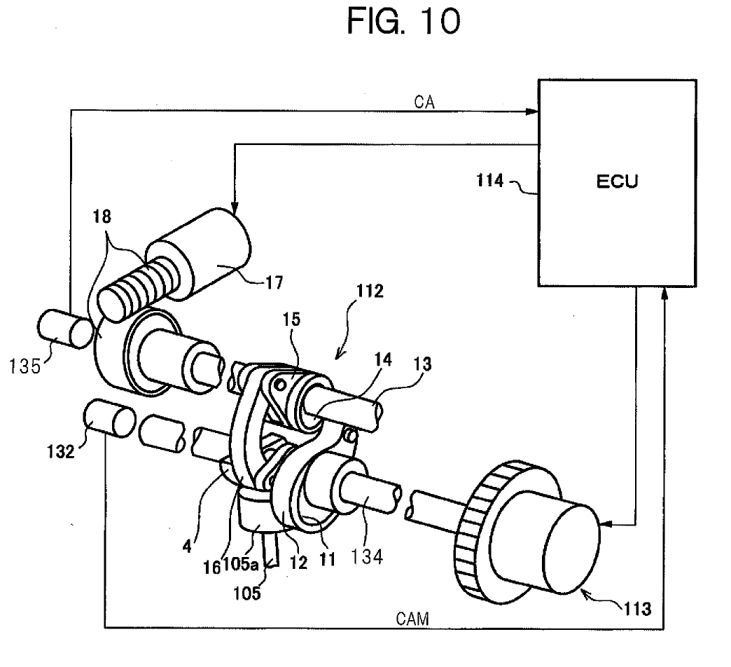

The variable valve lift mechanism 112 shown in FIG. 9 is a mechanism that is capable of continuously varying the valve operating angle together with the maximum valve lift amount of the inlet valve 105. To describe in detail, it is of a structure shown in the perspective view of FIG. 10.

In FIG. 10, above the inlet valve 105, there is rotatably supported inlet camshaft 134 that is rotation-driven by crankshaft 120.

An oscillating cam 4 that abuts against a valve lifter 105a of the inlet valve 105 to open and close inlet valve 105, is fitted around inlet camshaft 134 relatively rotatably.

Between inlet camshaft 3 and oscillating cam 4, there is provided variable valve lift mechanism 112 for continuously changing the valve operating angle and the maximum valve lift amount of inlet valve 105.

Moreover, on one end section of inlet camshaft 134, there is arranged variable valve timing mechanism 113 that is capable, by changing the rotation phase of inlet camshaft 134 with respect to crankshaft 120, of continuously changing the central phase of the valve operating angle of inlet valve 105.

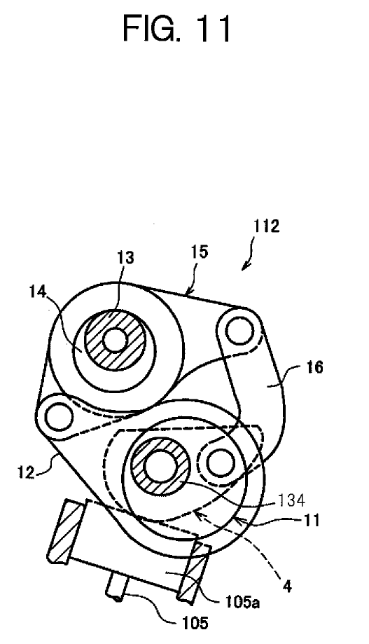

As shown in FIG. 10 and FIG. 11, the variable valve lift mechanism 112 includes: a circular drive cam 11 provided eccentrically and fixedly with respect to inlet camshaft 134; a ring-shaped link 12 externally fitted around drive cam 11 relatively rotatably; a control shaft 13 extending in the direction of the cylinder train substantially parallel with inlet camshaft 134; a circular control cam 14 provided eccentrically and fixedly with respect to control shaft 13; a rocker arm 15 fitted around this control cam 14 relatively rotatably with one end thereof being connected to the end of ring-shaped link 12; and a rod-shaped link 16 that is connected to the other end of rocker arm 15 and to oscillating cam 4.

Control shaft 13 is rotation driven via a gear train 18 by an actuator such as an electric motor 17.

As the actuator that rotation-drives control shaft 13, there may be used a hydraulic actuator. Moreover, as electric motor 17, for example, there may be used a DC motor, a brushless motor, or the like.

According to the configuration described above, when inlet camshaft 134 rotates in synchronization with crankshaft 120, ring-shaped link 12 makes a substantially translational movement via drive cam 11, and together with this, rocker arm 15 oscillates about the central axis of control cam 14, and oscillating cam 4 oscillates via rod-shaped link 16 to thereby drive inlet valve 105.

Moreover, by driving motor 17 to thereby change the rotation angle of control shaft 13, the position of the central axis of control cam 14, which is the center of oscillation of rocker arm 15, is changed to thereby change the posture of oscillating cam 4.

As a result, while the central phase of the valve operating angle of inlet valve 105 is maintained substantially constant, the valve operating angle and maximum valve lift amount of inlet valve 105 are continuously changed.

Variable valve lift mechanism 112 may be configured such that the central phase of the valve operating angle changes at the same time as when the valve operating angle and the maximum valve lift amount change continuously.

ECU 114 receives an input of a detection signal CA from an angle sensor 135 that detects a rotation angle of control shaft 13, and feedback-controls the manipulated value of motor 17 based on the detection value of angle sensor 135, so as to rotate control shaft 13 by a target angle corresponding to a target valve operating angle and target maximum valve lift amount.

Also in internal combustion engine 101 provided with variable valve lift mechanism 112, a target closing timing IVC is calculated according to the fuel properties such as alcohol concentration and octane number, and the presence or absence of knocking occurrence, as shown in any one of the flowcharts in FIG. 3, FIG. 6, FIG. 7, and FIG. 8.

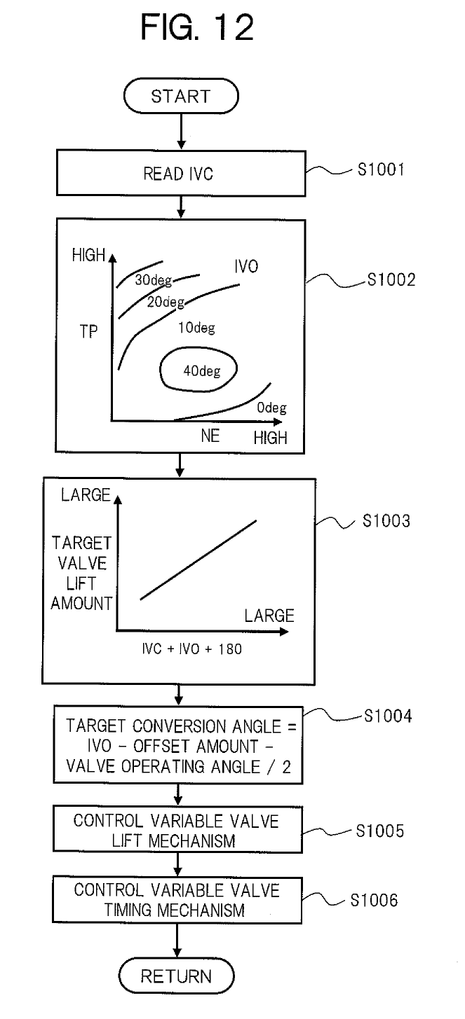

Control of variable valve lift mechanism 112 and variable valve timing mechanism 113 based on the target closing timing IVC, is performed as illustrated in the flowchart in FIG. 12.

The flowchart in FIG. 12 shows a routine that is executed interruptingly by ECU 114 at constant time intervals. First in step S1001, the target closing timing IVC that has been set according to the fuel properties such as alcohol concentration AD and octane number OC, and the presence or absence of knocking occurrence is read.

In step S1002, the target opening timing IVO of inlet valve 105 is calculated based on an engine torque TP and engine rotation speed NE indicating the operating conditions of the internal combustion engine 101.

In the present embodiment, the opening timing IVO is shown as an advanced angle from the top dead center TDC, and the opening timing IVO is close to the top dead center TDC when the angle of the opening timing IVO is smaller, and the opening timing IVO is at a position advanced from the top dead center TDC when the angle of the opening timing IVO is greater.

In a moderate load/moderate rotation range (range A), which is a steady travelling range, the target opening timing IVO is set to a value that is most advanced from the top dead center TDC, and in a range B that surrounds this moderate load/moderate rotation range, the opening timing IVO closest to the top dead center TDC is set. As the rotation speed becomes lower and the load becomes higher than those in the range B, the opening timing IVO is further advanced, and as the rotation speed becomes higher and the load becomes lower than those in the range B, the opening timing IVO is set so as to become even closer to the top dead center TDC.

The characteristics of the target opening timing IVO meet the requirements of a valve overlap amount for each operating condition. For example, the opening timing IVO in the range A is BTDC 40 deg, and the opening timing IVO in the range B is BTDC 10 deg.

In step S1003, a target valve lift amount of inlet valve 105 is calculated based on the target closing timing IVC and the target opening timing IVO.

Here, the opening timing IVO is an advanced angle from the top dead center TDC to the opening timing IVO; the closing timing IVC is a retarded angle from the bottom dead center BDC to the closing timing IVC; and the crank angle from the top dead center TDC to the bottom dead center BDC is 180 deg. Therefore, the crank angle from the opening timing IVO to the closing timing IVC is opening timing IVO+closing timing IVC+180 deg, and this corresponds to the valve operating angle of inlet valve 105.

Consequently, ECU 114, from the correlation between the valve operating angle and maximum valve lift amount in variable valve lift mechanism 112, finds a valve lift amount that corresponds to the valve operating angle of opening timing IVO+closing timing IVC+180 deg, as a target maximum valve lift amount.

Furthermore, ECU 114 converts the target maximum valve lift amount to a target angle of control shaft 13, and controls variable valve lift mechanism 112 so that the actual angle detected by angle sensor 135 becomes close to the target angle.

In step S1004, a target conversion angle in variable valve timing mechanism 113 is calculated according to the following formula.

Target conversion angle=target opening timing IVO−offset amount−valve operating angle/2

In the above formula, the target opening timing IVO is an advanced angle from the top dead center TDC to the opening timing IVO. Consequently, the result of subtracting a half of the valve operating angle from the target opening timing IVO is shown as a retarded angle from the top dead center TDC to the central phase of the valve operating angle of inlet valve 105.

Moreover the offset amount is an angle from the top dead center TDC to the central position of the valve operating angle in the initial state of variable valve timing mechanism 113.

Therefore, the target conversion angle is an angle difference between the central phase of the valve operating angle in the initial state of the variable valve timing mechanism 113, and the central phase of the valve operating angle required based on the target closing timing IVC and the target opening timing IVO.

That is to say, the target opening timing IVO set based on the engine operating conditions is fixed, and the closing timing IVC is set variable according to requirements for knocking suppression. According to such a configuration, requirements of a valve overlap amount according to engine operating conditions can be satisfied, and the control of the closing timing IVC that enables knocking suppression can be performed.

In step S1005, variable valve lift mechanism 112 is controlled based on the target maximum valve lift amount found in step S1003, and in step S1006, variable valve timing mechanism 113 is controlled based on the target conversion angle found in step S1004.

The entire contents of Japanese Patent Application No. 2009-070386, filed Mar. 23, 2009 are incorporated herein by reference.

While only selected embodiments have been chosen to illustrate the present invention, it will be apparent to those skilled in the art from this disclosure that various changes and modifications can be made herein without departing from the scope of the invention as defined in the appended claims.

Furthermore, the foregoing descriptions of the embodiments according to the present invention are provided for illustration only, and not for the purpose of limiting the invention as defined by the appended claims and their equivalents.

What is claimed is:

1. A control apparatus applied to an internal combustion engine provided with a variable valve mechanism that is capable of varying a closing timing of an inlet valve, the control apparatus comprising:
a detection unit that detects a knocking occurrence condition in the internal combustion engine; and
a control unit that controls the variable valve mechanism based on the knocking occurrence condition detected by the detection unit, and that changes a closing timing of the inlet valve in accordance with the knocking occurrence condition.

2. A control apparatus of an internal combustion engine according to claim 1, wherein
the detection unit detects a property of a fuel related to knocking occurrence, as a knocking occurrence condition.

3. A control apparatus of an internal combustion engine according to claim 2, wherein
the control unit retards the closing timing of the inlet valve from the bottom dead center, when the fuel property makes knocking occurrence more likely.

4. A control apparatus of an internal combustion engine according to claim 2, wherein
the control unit controls the variable valve mechanism based on a target closing timing of the inlet valve calculated based on the property of the fuel and operating conditions of the internal combustion engine.

5. A control apparatus of an internal combustion engine according to claim 2, wherein
the detection unit detects an octane number of the fuel as the property of the fuel related to knocking occurrence.

6. A control apparatus of an internal combustion engine according to claim 2, wherein
the detection unit detects an alcohol concentration of the fuel as the property of the fuel related to knocking occurrence.

7. A control apparatus of an internal combustion engine according to claim 1, wherein
the detection unit detects knocking vibrations of the internal combustion engine as a knocking occurrence condition.

8. A control apparatus of an internal combustion engine according to claim 7, wherein
the control unit retards the closing timing of the inlet valve from the bottom dead center in a case in which the detection unit has detected a knocking vibration occurrence, and the detection unit controls the variable valve mechanism to thereby bring the closing timing of the inlet valve close to the bottom dead center in a case in which the detection unit is detecting no knocking vibration occurrence.

9. A control apparatus of an internal combustion engine according to claim 1, wherein
the variable valve mechanism includes a variable valve timing mechanism that is capable of continuously varying a central phase of a valve operating angle of the inlet valve, and a variable valve lift mechanism that is capable of continuously varying a valve operating angle of the inlet valve, and
the control unit calculates a target opening timing of the inlet valve based on the operating conditions of the internal combustion engine, calculates a target closing timing of the inlet valve based on the knocking occurrence condition detected by the detection unit, calculates respectively an manipulated value of the variable valve timing mechanism and the variable valve lift mechanism based on the target opening timing and the target closing timing, and outputs the manipulated value.

10. A control apparatus applied to an internal combustion engine provided with a variable valve mechanism that is capable of varying a closing timing of an inlet valve, the control apparatus comprising:
a detection device that detects a knocking occurrence condition in the internal combustion engine; and
a control device that controls the variable valve mechanism based on the knocking occurrence condition detected by the detection device, and that changes a closing timing of the inlet valve in accordance with the knocking occurrence condition.

11. A control method of an internal combustion engine provided with a variable valve mechanism that is capable of varying a closing timing of an inlet valve comprising the steps of:
detecting a knocking occurrence condition in the internal combustion engine; and
controlling the variable valve mechanism based on the knocking occurrence condition, to thereby change a closing timing of the inlet valve according to the knocking occurrence condition.

12. A control method of an internal combustion engine according to claim 11, wherein
the step of detecting the knocking occurrence condition includes the step of;
detecting a property of a fuel related to knocking occurrence in the internal combustion engine.

13. A control method of an internal combustion engine according to claim 12, wherein
the step of changing a closing timing of the inlet valve includes the step of;
retarding the closing timing of the inlet valve from the bottom dead center when the property of the fuel makes knocking occurrence more likely.

14. A control method of an internal combustion engine according to claim 12, wherein
the step of changing a closing timing of the inlet valve includes the steps of:
calculating a target closing timing of the inlet valve based on the fuel property and the operating conditions of the internal combustion engine;
calculating an manipulated value of the variable valve mechanism based on the target closing timing; and
outputting the manipulated value to the variable valve mechanism.

15. A control method of an internal combustion engine according to claim 12, wherein
the step of detecting a property of a fuel detects an octane number of the fuel.

16. A control method of an internal combustion engine according to claim 12, wherein
the step of detecting a property of a fuel detects an alcohol concentration of the fuel.

17. A control method of an internal combustion engine according to claim 11, wherein
the step of detecting a knocking occurrence condition includes the step of:
detecting knocking vibrations of the internal combustion engine.

18. A control method of an internal combustion engine according to claim 17, wherein
the step of changing a closing timing of the inlet valve includes the step of:
retarding the closing timing of the inlet valve from the bottom dead center in a case in which knocking vibrations occur; and
bringing the closing timing of the inlet valve close to the bottom dead center in a case in which knocking vibrations are not occurring.

19. A control method of an internal combustion engine according to claim 11, wherein
the variable valve mechanism includes a variable valve timing mechanism that is capable of continuously varying a central phase of a valve operating angle of the inlet valve, and a variable valve lift mechanism that is capable of continuously varying a valve operating angle of the inlet valve, and
the step of changing a closing timing of the inlet valve includes the step of:
calculating a target opening timing of the inlet valve based on the operating conditions of the internal combustion engine;
calculating a target closing timing of the inlet valve based on the knocking occurrence condition;
calculating respectively an manipulated value of the variable valve timing mechanism and the variable valve lift mechanism based on the target opening timing and the target closing timing; and
outputting the manipulated value.
